(19) United States
(12) Patent Application Publication
(10) Pub. No.: US 2012/0007534 A1
(43) Pub. Date: Jan. 12, 2012

(54) ROTATION SPEED CONTROL DEVICE FOR A HEAT-DISSIPATING FAN

(75) Inventor: Ta-Lun KO, Kaohsiung City (TW)

(73) Assignee: NS MICRO MOTOR TECHNOLOGY CORP., Sijhih City (TW)

(21) Appl. No.: 12/895,343

(22) Filed: Sep. 30, 2010

(30) Foreign Application Priority Data
Jul. 8, 2010 (TW) 099122502

(51) Int. Cl. H02P 7/288

(52) U.S. Cl. 318/514

(57) ABSTRACT

A rotation speed control device for a heat-dissipating fan includes an impedance unit, a regulating unit, and a driving circuit. The impedance unit includes a first resistor having a first end connected to a first node, and a second end connected to a second node, and a second resistor having a third end connected to the second node, and a fourth end. The regulating unit is connected to the impedance unit and is configurable for varying an effective impedance of the impedance unit to adjust magnitude of current flowing through the impedance unit. The driving circuit is connected to the impedance unit and is adapted to control rotation speed of the heat-dissipating fan according to the magnitude of the current flowing through the impedance unit.

### CROSS-REFERENCE TO RELATED APPLICATION

This application claims priority of Taiwanese Application No. 099122502, filed on Jul. 8, 2010.

### BACKGROUND OF THE INVENTION

1. Field of the Invention

The invention relates to a rotation speed control device, more particularly to a rotation speed control device for a heat-dissipating fan.

2. Description of the Related Art

A conventional heat-dissipating fan for a personal computer or a server is designed for operation at different rotation speeds to meet different requirements. In order to make the speed of the heat-dissipating fan comply with customer specifications, a voltage-controlled integrated circuit is used in combination with a control circuit having a custom set of resistance values so that suitable magnitudes of current may be generated. However, since there are many points of solder connection between the voltage controlled integrated circuit and the aforesaid control circuit, faulty connections are commonly found between the integrated circuit and the control circuit.

Another solution for making the speed of the heat-dissipating fan comply with customer specifications is to generate suitable magnitudes of current by using coils having different coil diameters or different numbers of turns instead of by changing resistance values. However, because different coil materials are required, inventory problems and higher manufacturing costs are incurred.

### SUMMARY OF THE INVENTION

The object of the present invention is to provide a rotation speed control device capable of alleviating the aforesaid drawbacks of the prior art.

Accordingly, there is provided a rotation speed control device for a heat-dissipating fan including an impedance unit, a regulating unit, and a driving circuit. The impedance unit includes a first resistor having a first end connected to a first node, and a second end connected to a second node, and a second resistor having a third end connected to the second node, and a fourth end. The regulating unit is connected to the impedance unit and is configurable for varying an effective impedance of the impedance unit to adjust magnitude of current flowing through the impedance unit. The driving circuit is connected to the impedance unit and is adapted to control rotation speed of the heat-dissipating fan according to the magnitude of the current flowing through the impedance unit.

By virtue of the regulating unit of the rotation speed control device of the present invention, a variable impedance effect may be achieved without incurring higher manufacturing costs and inventory problems.

### BRIEF DESCRIPTION OF THE DRAWINGS

Other features and advantages of the present invention will become apparent in the fol lowing detailed description of the preferred embodiments with reference to the accompanying drawings, of which:

FIG. 1 is a circuit diagram for illustrating the first preferred embodiment of a rotation speed control device for a heat-dissipating fan according to the present invention; and

FIGS. 2 to 11 are circuit diagrams for illustrating other preferred embodiments of a rotation speed control device for a heat-dissipating fan according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

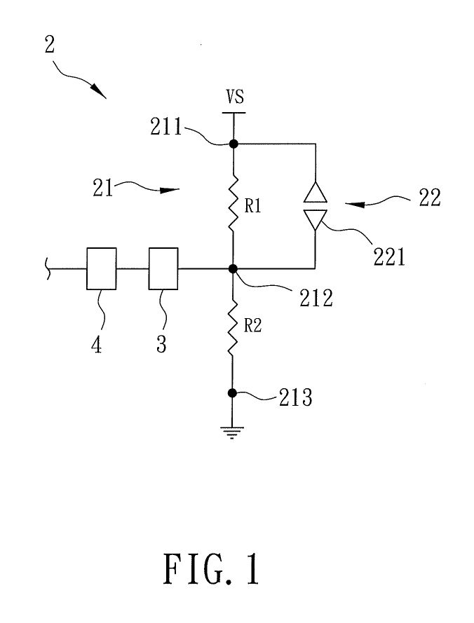

Referring to FIG. 1, the first preferred embodiment of a rotation speed control device 2 for a heat-dissipating fan according to the present invention is shown to include an impedance unit 21, a regulating unit 22, and a driving circuit 3.

The impedance unit 21 includes a first resistor R1 having a first end connected to a first node 211, and a second end connected to a second node 212, and a second resistor R2 having a third end connected to the second node 212, and a fourth end. In this embodiment, the fourth end of the second resistor R2 is connected to a third node 213.

The regulating unit 22 is connected to the impedance unit 21 and is configurable for varying an effective impedance of the impedance unit 21 to adjust magnitude of current flowing through the impedance unit 21. The driving circuit 3 is connected to the impedance unit 21 and is adapted to control rotation speed of the heat-dissipating fan according to the magnitude of the current flowing through the impedance unit 21.

In this embodiment, the regulating unit 22 includes a first flow control contact unit 221 connected to the first node 211 and the second node 212 and configurable for selectively bypassing the first resistor R1.

When the first flow control contact unit 221 is opened, current is able to flow through the first resistor R1 and the second resistor R2. When the first flow control contact unit 221 is closed, the current is able to flow through the first flow control contact unit 221 and the second resistor R2. Closing of the first flow control contact unit 221 may be conducted by, for example, soldering.

Described below is an example of an embodiment of the rotation speed control device 2. In the example, the first resistor R1 has a resistance of 5 ohms, and the second resistor R2 has a resistance of 10 ohms. When an effective resistance of 15 ohms is required, the first flow control contact unit 221 is opened, so that current is able to flow through the first resistor R1 and the second resistor R2 so as to meet the requirement of an effective resistance of 15 ohms. On the other hand, when an effective resistance of 10 ohms is required, the first flow control contact unit 221 is closed, so that current is able to flow through the first flow control contact unit 221 and the second resistor R2 and does not flow through the first resistor R1 so as to meet the requirement of an effective resistance of 10 ohms.

In this embodiment, the driving circuit 3 is connected to the second node 212, and is further connected to a stator coil 4 of the heat-dissipating fan. Since the feature of the invention does not reside in the specific configuration of the driving circuit 3 and how it drives rotation of the heat-dissipating fan, further details of the same are omitted herein for the sake of brevity.

It is noted that the first flow control contact unit 221 may be connected electrically to the second node 212 and the third node 213 for selectively bypassing the second resistor R2 in other embodiments of the invention.

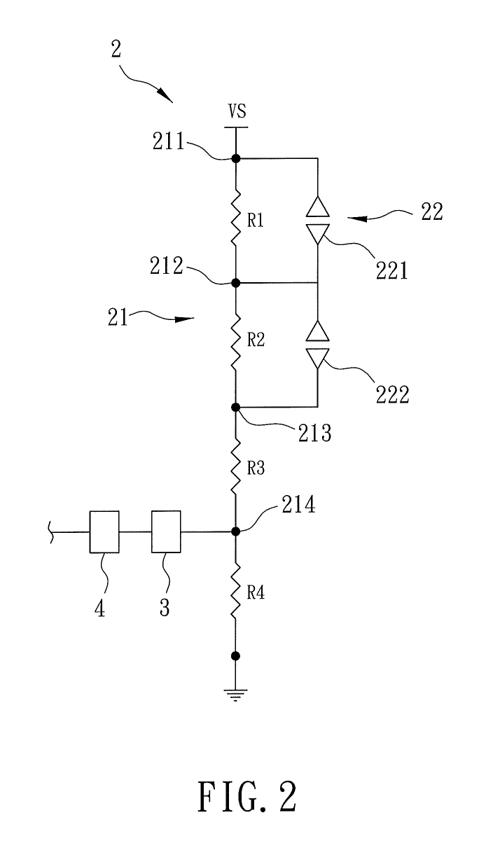

Referring to FIG. 2, the second preferred embodiment of the rotation speed control device 2 for a heat-dissipating fan according to the present invention is generally similar to the first preferred embodiment in structure. In the second embodiment, the impedance unit 21 further includes a third resistor R3 having a fifth end connected to the fourth end of the second resistor R2 at the third node 213, and a sixth end connected to a fourth node 214, and a fourth resistor R4 having a seventh end connected to the fourth node 214, and an eighth end.

In this embodiment, the regulating unit 22 includes a first flow control contact unit 221 connected to the first node 211 and the second node 212 and configurable for selectively bypassing the first resistor R1, and a second flow control contact unit 222 connected to the second node 212 and the third node 213 and configurable for selectively bypassing the second resistor R2.

When the first flow control contact unit 221 and the second flow control contact unit 222 are both opened, current is able to flow through the first resistor R1, the second resistor R2, the third resistor R3 and the fourth resistor R4. When the first flow control contact unit 221 is closed and the second flow control contact unit 222 is opened, current is able to flow through the first flow control contact unit 221, the second resistor R2, the third resistor R3 and the fourth resistor R4. When the first flow control contact unit 221 is opened and the second flow control contact unit 222 is closed, current is able to flow through the first resistor R1, the second flow control contact unit 222, the third resistor R3 and the fourth resistor R4. When the first flow control contact unit 221 and the second flow control contact unit 222 are both closed, current is able to flow through the first flow control contact unit 221, the second flow control contact unit 222, the third resistor R3 and the fourth resistor R4. While the driving circuit 3 is connected to the fourth node 214 in this embodiment, the connection between the driving circuit 3 and the impedance unit 21 should not be limited to what is disclosed herein.

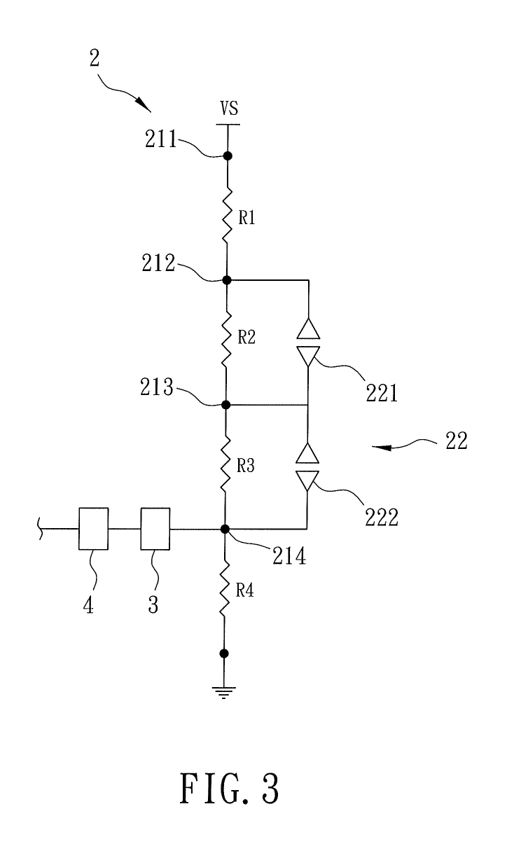

Referring to FIG. 3, the third preferred embodiment of the rotation speed control device 2 for a heat-dissipating fan according to the present invention is generally similar to the second preferred embodiment in structure. In the third embodiment, the regulating unit 22 includes a first flow control contact unit 221 connected to the second node 212 and the third node 213 and configurable for selectively bypassing the second resistor R2, and a second flow control contact unit 222 connected to the third node 213 and the fourth node 214 and configurable for selectively bypassing the third resistor R3.

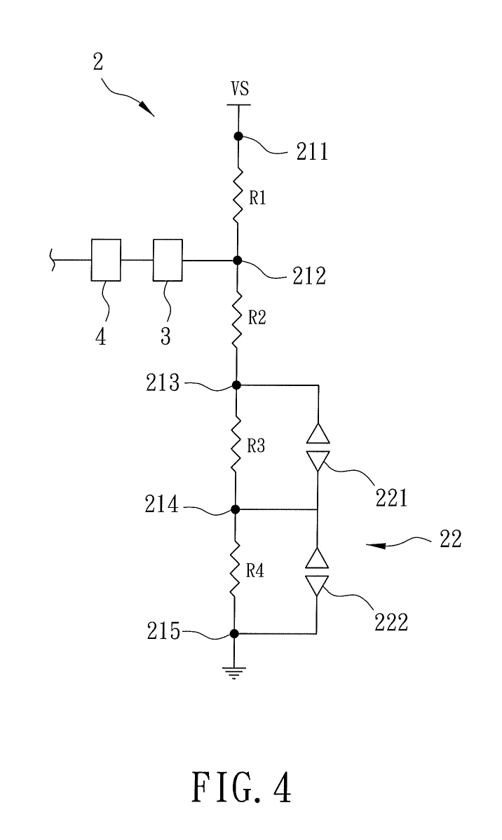

Referring to FIG. 4, the fourth preferred embodiment of the rotation speed control device 2 for a heat-dissipating fan according to the present invention is generally similar to the second preferred embodiment in structure. In the fourth embodiment, the eighth end of the fourth resistor R4 is connected to a fifth node 215, and the regulating unit 22 includes a first flow control contact unit 221 connected to the third node 213 and the fourth node 214 and configurable for selectively bypassing the third resistor R3, and a second flow control contact unit 222 connected to the fourth node 214 and the fifth node 215 and configurable for selectively bypassing the fourth resistor R4. The driving circuit 3 is connected to the second node 212 in this embodiment.

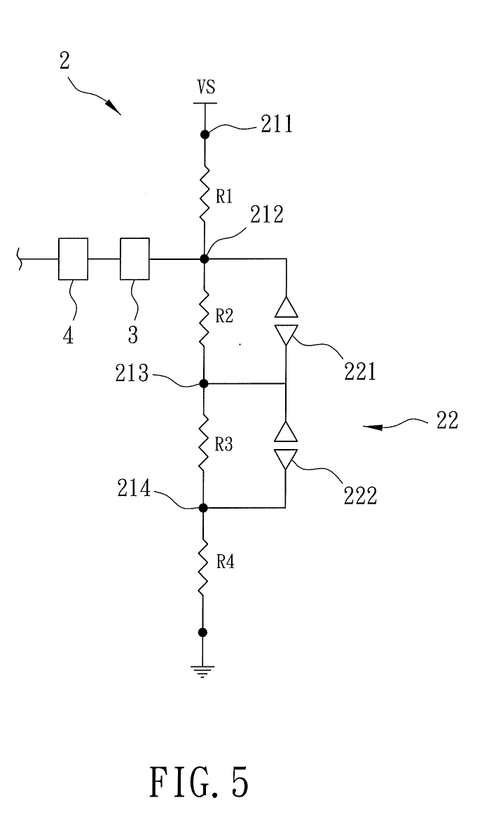

Referring to FIG. 5, the fifth preferred embodiment of the rotation speed control device 2 for a heat-dissipating fan according to the present invention differs from the third preferred embodiment (see FIG. 3) only in that the driving circuit 3 is connected to the second node 212.

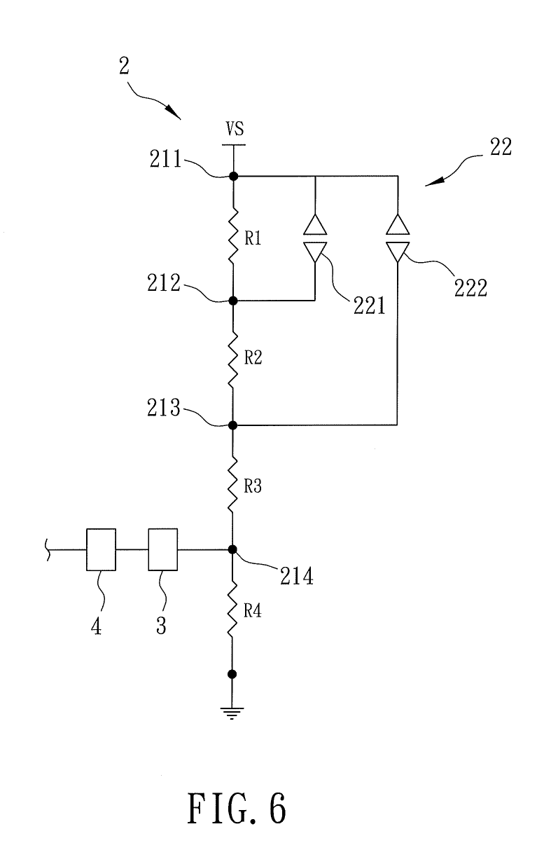

Referring to FIG. 6, the sixth preferred embodiment of the rotation speed control device 2 for a heat-dissipating fan according to the present invention differs from the second preferred embodiment in the configuration of the regulating unit 22. In the sixth embodiment, the regulating unit 22 includes a first flow control contact unit 221 connected to the first node 211 and the second node 212 and configurable for selectively bypassing the first resistor R1, and a second flow control contact unit 222 connected to the first node 211 and the third node 213 and configurable for selectively bypassing a series combination of the first resistor R1 and the second resistor R2.

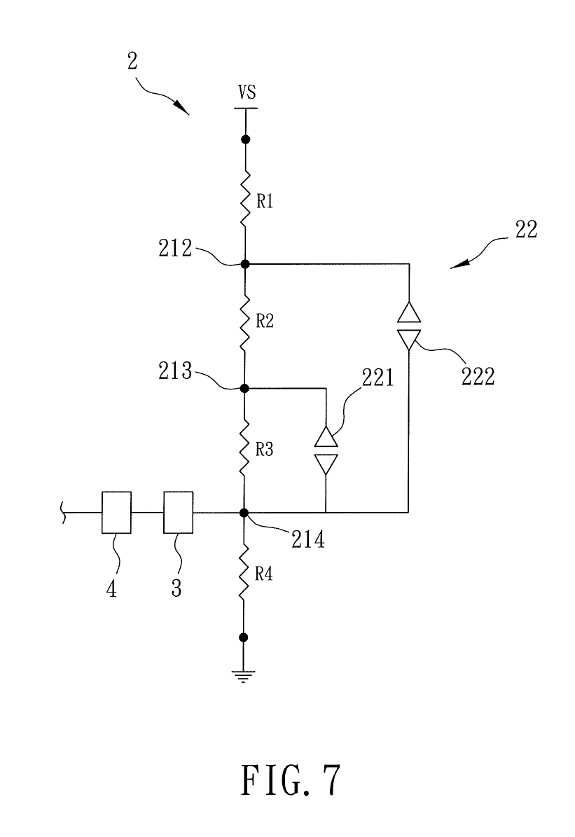

Referring to FIG. 7, the seventh preferred embodiment of the rotation speed control device 2 for a heat-dissipating fan according to the present invention is generally similar to the sixth preferred embodiment in structure. In the seventh embodiment, the regulating unit 22 includes a first flow control contact unit 221 connected to the third node 213 and the fourth node 214 and configurable for selectively bypassing the third resistor R3, and a second flow control contact unit 222 connected to the second node 212 and the fourth node 214 and configurable for selectively bypassing a series combination of the second resistor R2 and the third resistor R3.

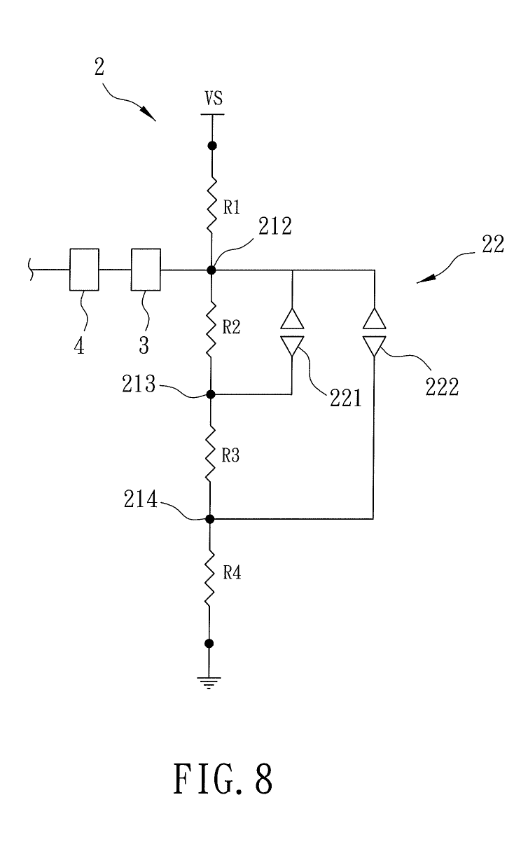

Referring to FIG. 8, the eighth preferred embodiment of the rotation speed control device 2 for a heat-dissipating fan according to the present invention is generally similar to the sixth preferred embodiment in structure. In the eighth embodiment, the regulating unit 22 includes a first flow control contact unit 221 connected to the second node 212 and the third node 213 and configurable for selectively bypassing the second resistor R2, and a second flow control contact unit 222 connected to the second node 212 and the fourth node 214 and configurable for selectively bypassing a series combination of the second resistor R2 and the third resistor R3. The driving circuit 3 is connected to the second node 212 in this embodiment.

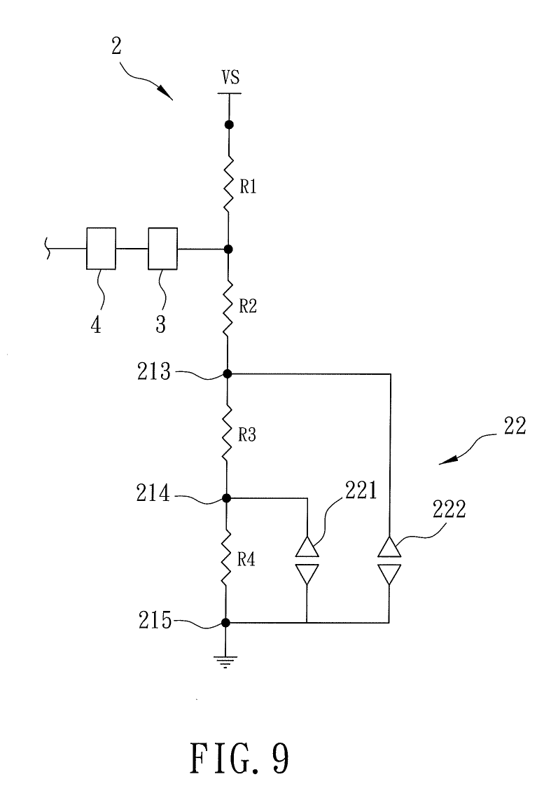

Referring to FIG. 9, the ninth preferred embodiment of the rotation speed control device 2 for a heat-dissipating fan according to the present invention is generally similar to the eighth preferred embodiment in structure. In the ninth embodiment, the regulating unit 22 includes a first flow control contact unit 221 connected to the fourth node 214 and the fifth node 215 and configurable for selectively bypassing the fourth resistor R4, and a second flow control contact unit 222 connected to the third node 213 and the fifth node 215 and configurable for selectively bypassing a series combination of the third resistor R3 and the fourth resistor R4.

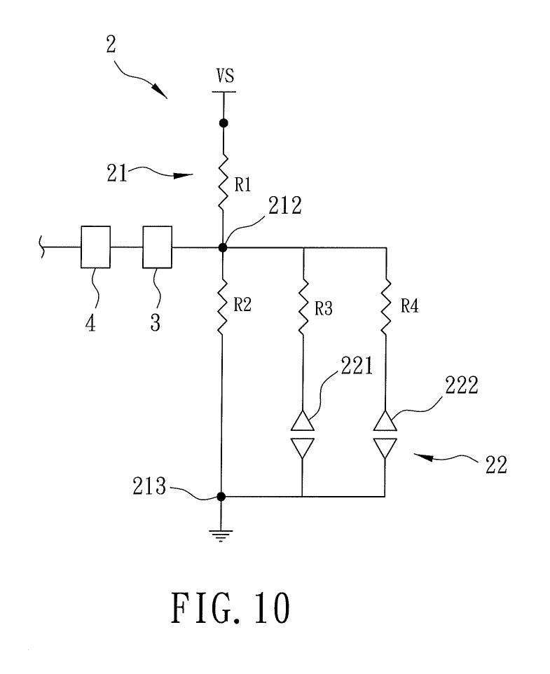

Referring to FIG. 10, the tenth preferred embodiment of the rotation speed control device 2 for a heat-dissipating fan according to the present invention is generally similar to the first preferred embodiment in structure. In the tenth embodiment, the impedance unit 21 further includes a third resistor R3 having a fifth end connected to the second node 212, and a sixth end, and a fourth resistor having a seventh end connected to the second node 212, and an eighth end. In this embodiment, the regulating unit 22 includes a first flow control contact unit 221 connected to the sixth end of the third resistor R3 and the third node 213 and configurable to close or open electrical connection therebetween, and a second flow control contact unit 222 connected to the eighth end of the fourth resistor R4 and the third node 213 and configurable to close or open electrical connection therebetween.

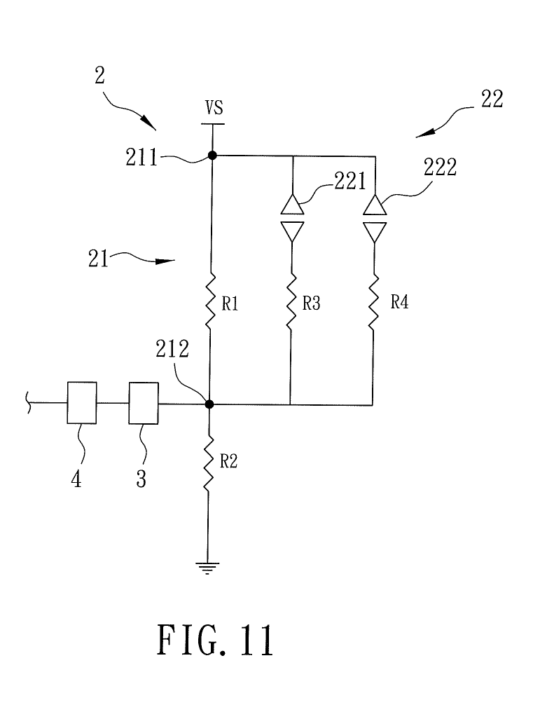

Referring to FIG. 11, the eleventh preferred embodiment of the rotation speed control device 2 for a heat-dissipating fan according to the present invention is generally similar to the tenth preferred embodiment in structure. In the eleventh embodiment, the regulating unit 22 includes a first flow control contact unit 221 connected to the sixth end of the third resistor R3 and the first node 211 and configurable to close or open electrical connection therebetween, and a second flow control contact unit 222 connected to the eighth end of the fourth resistor R4 and the first node 211 and configurable to close or open electrical connection therebetween.

In the following Table 1, the electrical potentials and rotation speeds for various possible connections in the second to eleventh embodiments are shown. It should be noted herein that FIGS. 3 to 11 show non-limiting embodiments, and those skilled in the art may readily appreciate other modifications in terms of connections, such as an increase in the number of resistors, based on the disclosed embodiments.

TABLE 1

Fan speed

| | High | Medium | Low |
|---|---|---|---|
| | Output potential | | |
| | Low | Medium | High |
| FIG. 2 | Contact units | Only contact | Contact units |
| | 221, 222 are | unit 221 or 222 | 221, 222 are |
| | both open | is open | both closed |
| FIG. 3 | Contact units | Only contact | Contact units |
| | 221, 222 are | unit 221 or 222 | 221, 222 are |
| | both open | is open | both closed |
| FIG. 4 | Contact units | Only contact | Contact units |
| | 221, 222 are | unit 221 or 222 | 221, 222 are |
| | both closed | is closed | both open |
| FIG. 5 | Contact units | Only contact | Contact units |
| | 221, 222 are | unit 221 or 222 | 221, 222 are |
| | both closed | is closed | both open |
| FIG. 6 | Contact units | Only contact | Contact unit |
| | 221, 222 are | unit 221 is | 222 is closed |
| | both open | closed | |
| FIG. 7 | Contact units | Only contact | Contact unit |
| | 221, 222 are | unit 221 is | 222 is closed |
| | both open | closed | |
| FIG. 8 | Contact unit | Only contact | Contact units |
| | 222 is closed | unit 221 is | 221, 222 are |
| | | closed | both open |
| FIG. 9 | Contact unit | Only contact | Contact units |
| | 222 is closed | unit 221 is | 221, 222 are |
| | | closed | both open |
| FIG. 10 | Only contact | Only contact | Contact units |
| | unit 221 is | unit 222 is | 221, 222 are |
| | closed | closed | both open |
| FIG. 11 | Contact units | Only contact | Only contact |
| | 221, 222 are | unit 222 is | unit 221 is |
| | both open | closed | closed |

In the second to eleventh embodiments, apart from achieving the same effect as the first preferred embodiment, variations of the effective resistances of the rotation speed control device 2 are increased in number to expand flexibility of the same.

In summary, by virtue of the regulating unit 22 of the rotation speed control device 2 of the present invention, a variable impedance effect may be achieved without incurring higher manufacturing costs and inventory problems.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A rotation speed control device for a heat-dissipating fan, comprising:
an impedance unit including
a first resistor having a first end connected to a first node, and a second end connected to a second node, and
a second resistor having a third end connected to said second node, and a fourth end;
a regulating unit connected to said impedance unit and configurable for varying an effective impedance of said impedance unit to adjust magnitude of current flowing through said impedance unit; and
a driving circuit connected to said impedance unit and adapted to control rotation speed of the heat-dissipating fan according to the magnitude of the current flowing through said impedance unit.

2. The rotation speed control device as claimed in claim 1, wherein said regulating unit includes a first flow control contact unit connected to said first node and said second node and configurable for selectively bypassing said first resistor.

3. The rotation speed control device as claimed in claim 1, wherein said impedance unit further includes
a third resistor having a fifth end connected to said fourth end of said second resistor at a third node, and a sixth end connected to a fourth node, and
a fourth resistor having a seventh end connected to said fourth node, and an eighth end.

4. The rotation speed control device as claimed in claim 3, wherein said regulating unit includes a first flow control contact unit connected to said first node and said second node and configurable for selectively bypassing said first resistor, and a second flow control contact unit connected to said second node and said third node and configurable for selectively bypassing said second resistor.

5. The rotation speed control device as claimed in claim 3, wherein said regulating unit includes a first flow control contact unit connected to said second node and said third node and configurable for selectively bypassing said second resistor, and a second flow control contact unit connected to said third node and said fourth node and configurable for selectively bypassing said third resistor.

6. The rotation speed control device as claimed in claim 3, wherein said eighth end of said fourth resistor is connected to a fifth node, and said regulating unit includes a first flow control contact unit connected to said third node and said fourth node and configurable for selectively bypassing said third resistor, and a second flow control contact unit connected to said fourth node and said fifth node and configurable for selectively bypassing said fourth resistor.

7. The rotation speed control device as claimed in claim 3, wherein said regulating unit includes a first flow control contact unit connected to said first node and said second node and configurable for selectively bypassing said first resistor, and a second flow control contact unit connected to said first node and said third node and configurable for selectively bypassing a series combination of said first and second resistors.

8. The rotation speed control device as claimed in claim 3, wherein said regulating unit includes a first flow control contact unit connected to said third node and said fourth node and configurable for selectively bypassing said third resistor, and a second flow control contact unit connected to said second node and said fourth node and configurable for selectively bypassing a series combination of said second and third resistors.

9. The rotation speed control device as claimed in claim 3, wherein said regulating unit includes a first flow control contact unit connected to said second node and said third node and configurable for selectively bypassing said second resistor, and a second flow control contact unit connected to said second node and said fourth node and configurable for selectively bypassing a series combination of said second and third resistors.

10. The rotation speed control device as claimed in claim 3, wherein said eighth end of said fourth resistor is connected electrically to a fifth node, and said regulating unit includes a first flow control contact unit connected to said fourth node and said fifth node and configurable for selectively bypassing said fourth resistor, and a second flow control contact unit connected to said third node and said fifth node and configurable for selectively bypassing a series combination of said third and fourth resistors.

11. The rotation speed control device as claimed in claim 1, wherein said impedance unit further includes
a third resistor having a fifth end connected to said second node, and a sixth end, and
a fourth resistor having a seventh end connected to said second node, and an eighth end.

12. The rotation speed control device as claimed in claim 11, wherein said regulating unit includes a first flow control contact unit connected to said sixth end of said third resistor and said third node and configurable to close or open electrical connection therebetween, and a second flow control contact unit connected to said eighth end of said fourth resistor and said third node and configurable to close or open electrical connection therebetween.

13. The rotation speed control device as claimed in claim 11, wherein said regulating unit includes a first flow control contact unit connected to said sixth end of said third resistor and said first node and configurable to close or open electrical connection therebetween, and a second flow control contact unit connected to said eighth end of said fourth resistor and said first node and configurable to close or open electrical connection therebetween.
